(19) United States
(12) Patent Application Publication
(10) Pub. No.: US 2026/0142864 A1
(43) Pub. Date: May 21, 2026

(54) SYSTEMS, METHODS, AND APPARATUS FOR PRUNED CONSTELLATIONS

(71) Applicant: Huawei Technologies Co., Ltd., Shenzhen (CN)

(72) Inventors: Ming Jia, Ottawa (CA); Jianglei Ma, Ottawa (CA)

(21) Appl. No.: 19/435,343

(22) Filed: Dec. 29, 2025

Related U.S. Application Data
(63) Continuation of application No. PCT/CN2023/133341, filed on Nov. 22, 2023.
(60) Provisional application No. 63/511,201, filed on Jun. 30, 2023.

(51) Int. Cl. H04L 27/36; H04L 27/34; H04L 27/38

(52) U.S. Cl. CPC H04L 27/361; H04L 27/3411; H04L 27/38

(57) ABSTRACT

Input bits are mapped to produce modulated symbols, and the modulated symbols can be demodulated to recover the input bits, based on a first constellation. The first constellation may be referred to as a pruned constellation, and includes constellation points that are consistent with a portion of a second constellation. That portion of the second constellation excludes a first subset of constellation points in the second constellation that are associated with lowest power and a second subset of constellation points in the second constellation that are associated with highest power. In this sense, it may be considered that the first constellation is obtained by pruning lowest power and highest power constellation points from the second constellation. Dynamic range of power associated with constellation points is smaller in the first constellation than the second constellation. Average power of constellation points may be substantially the same in the first and second constellations.

### CROSS-REFERENCE TO RELATED APPLICATION

The present application is a continuation of International Application No. PCT/CN2023/133341, filed on Nov. 22, 2023, which claims the benefit of U.S. Provisional Patent Application Ser. No. 63/511,201, entitled “System, Method, and Apparatus for Pruned QAM for OFDM-Based Waveform”, filed on Jun. 30, 2023. The entire contents of each of the aforementioned applications are hereby incorporated by reference.

### TECHNICAL FIELD

The present application relates generally to communications, and in particular to modulation and constellations.

### BACKGROUND

Sensing is playing an increasingly important role in future wireless networks, especially for emerging applications such as smart transportation, smart home, smart cities, and various location-based services. In addition, due to the rapid growth of wireless services and mobile terminals, sensing can utilize/share the same equipment and/or waveform that has already been installed/used for communication. Not only so, the shared equipment and/or waveform can also simultaneously perform the tasks of both communication and sensing simultaneously using the same signal on the same spectrum at the same time. This type of techniques is often referred to as ISAC (integrated sensing and communication), and in this regard OFDM has been widely viewed as a practical candidate waveform.

OFDM refers to orthogonal frequency division multiplexing. SC-FDMA, referenced below, refers to single-carrier frequency division multiple access, and is also known as discrete Fourier transform-spread OFDM (DFT-s-OFDM).

Phase noise exhibits different behaviors in OFDM and SC-FDMA, as shown in FIG. 1 (from V. Syrjala, “Modelling and Practical Iterative Mitigation of Phase Noise in SC-FDMA”, PIMRC' 12, pp. 2395-2400). FIG. 1 shows that, in SC-FDMA, phase noise only spreads in phase. In addition, phase noise is a process in time, which makes it easier to compensate. For this reason, SC-FDMA is more resilient to phase noise than OFDM.

It should be noted that inter-symbol-interference (ISI) and phase noise are two different issues, although both can be addressed using reference signals. In SC-FDMA, phase-noise has a limited distribution between consecutive pulses, which can be addressed by differential phase modulation. Differential phase modulation may also be referred to as differential phase encoding. However, differential phase encoding cannot solve the ISI problem.

It may be desirable to provide techniques for modulation that results in lower power dynamic range.

### SUMMARY

The present disclosure includes examples of pruned QAM for applications that may benefit from much reduced power dynamic range, such as OFDM-based sensing and differential modulation. Although QAM is used as an example, other types of constellations can also be pruned in a similar way to achieve the same objectives.

QAM refers to quadrature amplitude modulation.

According to an aspect of the present disclosure, a method involves mapping input bits, based on a first constellation, to produce modulated symbols, and outputting the modulated symbols.

Another method disclosed herein involves receiving modulated symbols and demodulating the modulated symbols based on a first constellation, to recover input bits.

An apparatus according to an embodiment includes a modulator for mapping input bits, based on a first constellation, to produce modulated symbols; and an interface, coupled to the modulator, for outputting the modulated symbols.

Another apparatus disclosed herein includes an interface for receiving modulated symbols, and a demodulator, coupled to the receiver, for demodulating the modulated symbols based on a first constellation, to recover input bits.

A system is also disclosed, and may include: a first communication device configured to map input bits, based on a first constellation, to produce modulated symbols, and to transmit the modulated symbols; and a second communication device configured to receive the modulated symbols and to demodulate the modulated symbols to recover the input bits.

In these examples, and others herein, the first constellation includes constellation points that are consistent with a portion of a second constellation, and that portion of the second constellation excludes a first subset of constellation points in the second constellation that are associated with lowest power and a second subset of constellation points in the second constellation that are associated with highest power.

In other apparatus embodiments, an apparatus may include a processor configured to cause the apparatus to perform any of the methods as disclosed herein.

An apparatus may include a processor and a non-transitory computer readable storage medium that is coupled to the processor and stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 illustrates phase noise in OFDM and SC-FDMA.

FIG. 2 is a simplified schematic illustration of a communication system.

FIG. 3 is a block diagram illustration of the example communication system in FIG. 1.

FIG. 4 illustrates an example electronic device and examples of base stations.

FIG. 5 illustrates units or modules in a device.

FIG. 6 illustrates an 8-point constellation derived from 16 QAM.

FIG. 7 illustrates a 32-point constellation derived from 64 QAM.

FIG. 8 illustrates amplitude distribution of a pruned 64 QAM and a regular 64 QAM.

FIG. 9A illustrates amplitude distribution of a pruned 64 QAM and a regular 64 QAM.

FIG. 9B illustrates amplitude distribution of a regular 64 QAM.

FIG. 9C illustrates amplitude distribution of a pruned 64 QAM.

FIG. 10 illustrates PAPR of pruned 64 QAM SC-FDMA and regular 64 QAM SC-FDMA.

FIG. 11 illustrates a 64-point amplitude and phase-shift keying (APSK) constellation.

FIG. 12 is a flow diagram illustrating more general example methods according to embodiments.

FIG. 13 is a block diagram illustrating an example apparatus.

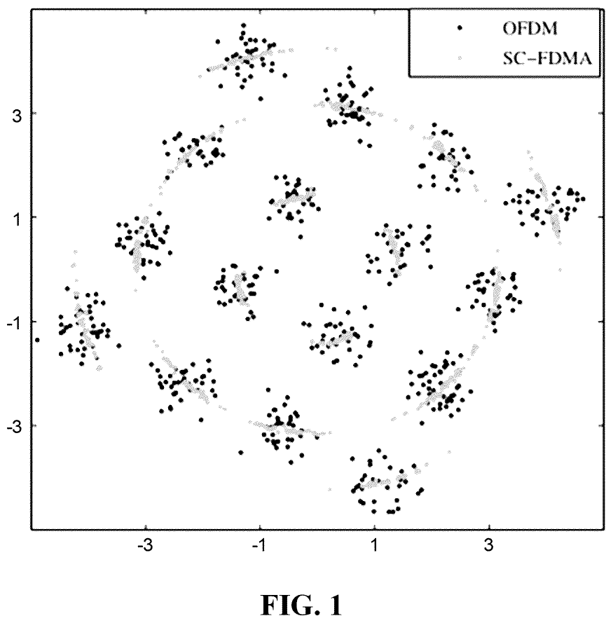

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

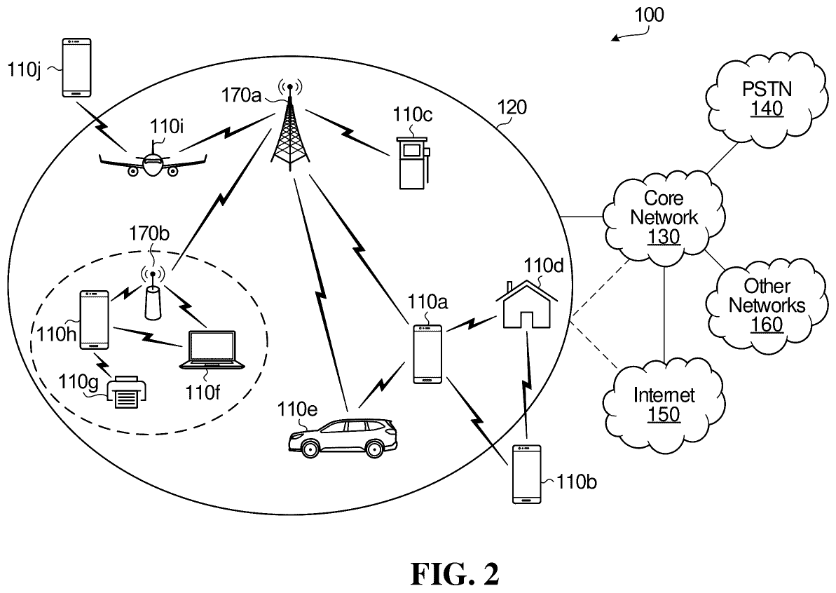

Referring to FIG. 2, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

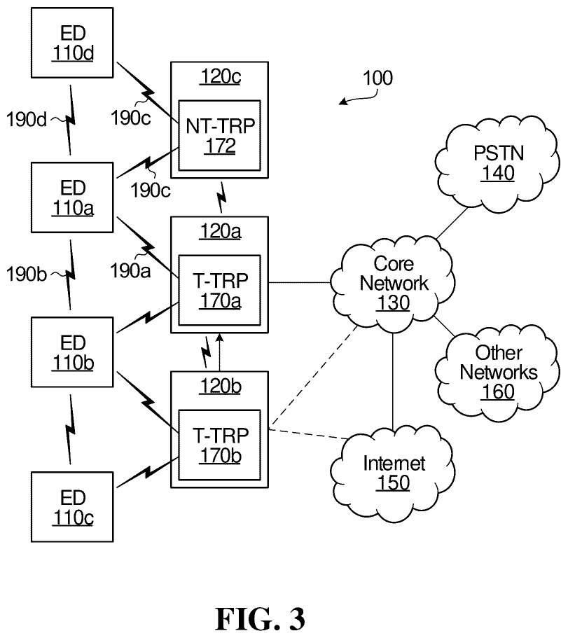

FIG. 3 illustrates an example communication system 100. In general, the communication system 100 enables multiple wireless or wired elements to communicate data and other content. The purpose of the communication system 100 may be to provide content, such as voice, data, video, signaling, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 3, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Discrete Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, 110c with various services such as voice, data and other services. The RANS 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

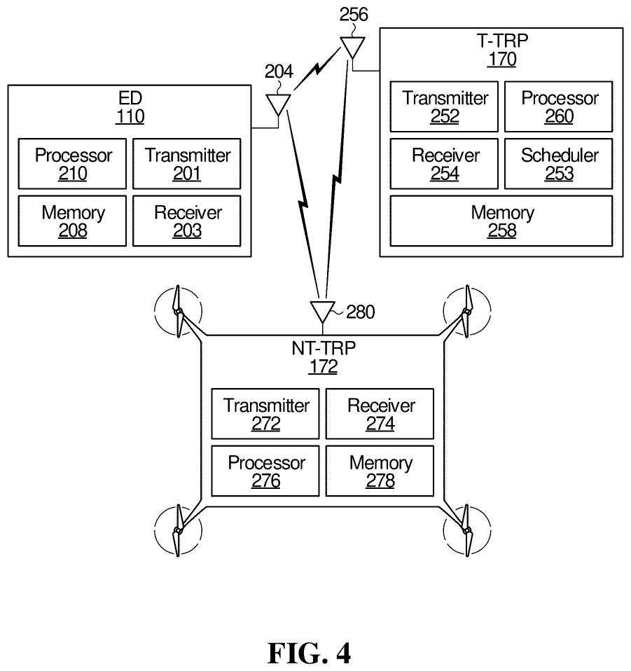

FIG. 4 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the forgoing devices, among other possibilities. Future generation EDs 110 may be referred to using other terms. Each base station 170a and 170b is a T-TRP and will, hereafter, be referred to as T-TRP 170. Also shown in FIG. 4, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 2). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

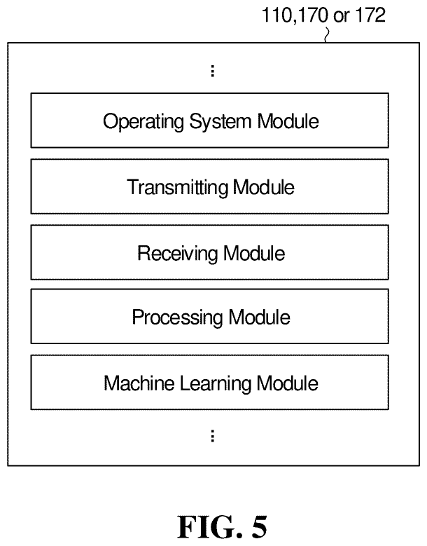

One or more steps of the embodiment methods provided herein may be performed by corresponding units or modules, according to FIG. 5. FIG. 5 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or by a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

### OFDM Based ISAC

OFDM can perform the task of both communication and sensing. However, it is usually assumed that the modulation used is QPSK, so that the signal spectrum is flat.

QPSK refers to quadrature phase shift keying.

At the receiver, a divider is often used to remove the transmitted signal, and thus only the sensing information is left for further processing. However, a different way can also be used: multiplying the conjugate of the transmitted signal in the frequency domain, which is equivalent to circular correlation in the time domain. For OFDM with QPSK modulation, these two approaches are equivalent to each other, but when the frequency domain sensing signal is not constant modulus, they are different. While division can result in the best ambiguity function, dividing low amplitude sensing signals can cause significant noise enhancement; on the other hand, while multiplication does not cause noise enhancement, due to the fact that the random power component of the sensing signal is not removed, its ambiguity function can have much higher side-lobe floor. Both effects are undesirable for sensing; therefore, how to do sensing with a high-order-QAM OFDM signal is still an open question.

### Differential Phase Modulation

Examples of differential phase modulation include differentially encoded PSK and DPSK. In DPSK, since the amplitudes of the modulated symbols remain constant, only the problem of phase ambiguity needs to be solved. This differential phase encoding technique can be extended to non-constant-modulus QAM signals, when only the phase ambiguity problem arises, such as phase noise in mmWave. The amplitude of the modulated QAM, however, still needs to be recovered from regular DM-RS. The reason to use differential phase modulation when DM-RS is present will be explained later.

PSK refers to phase shift keying. DPSK refers to differential phase shift keying. mmWave refers to millimeter-wave. DM-RS refers to demodulation reference signal.

The concept of differential QAM phase encoding is shown in Table 1 below. In practice, the following Equation (1) is used to recover the phase of (θ_{C}+(θ_{PC}−θ_{PB})+(θ_{NC}−θ_{NB})) at the receiver.

$${{C}_{r}^{′} ( {B}_{r}^{′} )}^{*} = ( {α}_{B} + {α}_{NB} ) ( {α}_{C} + {α}_{NC} ) {e}^{j ( {θ}_{C} + ( {θ}_{PC} - {θ}_{PB} ) + ( {θ}_{NC} - {θ}_{NB} ) )} \qquad Equation ( 1 )$$

TABLE 1
Differential QAM phase modulation

| | Differentially | |
|---|---|---|
| QAM signal | modulated signal | Recovered QAM signal |
| A(α_{A}, θ_{A}) | A′(α_{A}, θ_{A′} = θ_{A}) | A(α_{A} + α_{NA}, θ_{A} + θ_{PA} + θ_{NA}) |
| B(α_{B}, θ_{B}) | B′(α_{B}, θ_{B′} = θ_{A′} + | B(α_{B} + α_{NB}, θ_{B} + (θ_{PB} − θ_{PA}) + |
| | θ_{B}) | (θ_{NB} − θ_{NA})) |
| C(α_{C}, θ_{C}) | C′(α_{B}, θ_{C′} = θ_{B′} + | C(α_{C} + α_{NC}, θ_{C} + (θ_{PC} − θ_{PB}) + |
| | θ_{C}) | (θ_{NC} − θ_{NB})) |
| . | . | . |
| . | . | . |
| . | . | . |

### The Use of Differentially Phase Encoded QAM

To tackle the problem of phase noise, the most commonly used technique is to insert phase-tracking reference signals. These phase-tracking reference signals do not carry any information, and hence are a waste of resources, especially when SNR is high. A more efficient way is to use decision-feedback of successfully decoded differentially phase encoded QAM signal as phase-tracking reference signals.

PT-RS may be used to refer to a phase-tracking reference signal. SNR refers to signal-to-noise ratio.

### The Issue of Differentially Phase Encoded QAM

In classic differential modulation, a PSK constellation is used, which has constant modulus. In higher order QAM, each constellation point can have different amplitude, and this brings in a problem: a constellation point with a small amplitude can have larger phase noise caused by the noise (θ_{NA}, θ_{NB}, . . . , in Table 1), which can contaminate the high amplitude constellation points that are differently encoded with it. In addition, when used as PT-RS, constellation points with small amplitude can also result in large phase estimation error. Both issues point to the same direction: the need to avoid a large QAM amplitude range.

### Pruned QAM

As explained earlier, both the noise enhancement (or unremoved random signal power) in sensing and the large phase noise caused by the noise (θ_{NA}, θ_{NB}, . . . , in Table 1) is due to the fact that the transmitted signal is not constant modulus. High order PSK does not work well for communication; how can a signal be created which is not strictly constant modulus but is close, yet still has the desired quality of QAM for communication? With these considerations in mind, comes “pruned QAM”.

Herein, “pruned QAM” is used as an illustrative example. It should be appreciated that not all embodiments necessarily involve pruning. A constellation may be provided or obtained without explicitly pruning points from a larger, base constellation. Selecting preferred points from a base constellation, for example, may have the same effect as pruning non-preferred points from the base constellation, for example. A constellation or points thereof may be described or specified, in a communication standard for example, in which case a constellation is obtained based on the description or specification rather than by pruning or otherwise changing a base constellation so that only preferred points remain. Embodiments are also not limited to QAM.

References to pruned QAM should be interpreted accordingly. Features that are disclosed by way of example with reference to pruned QAM may also or instead be applied to other embodiments, which may or may not involve pruning, and which may or may not involve QAM or QAM constellations.

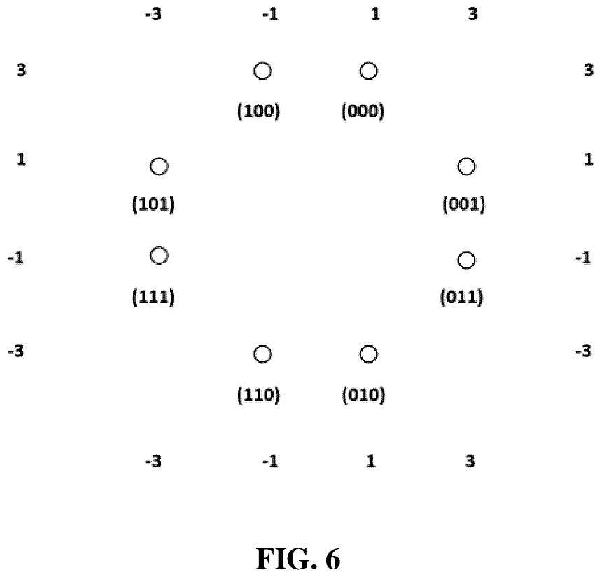

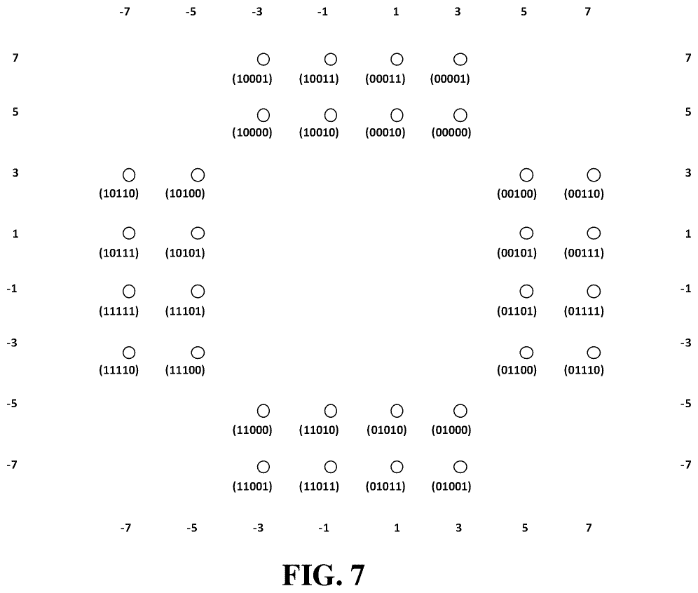

The idea of “pruned QAM” is as follows. By sacrificing 1-bit from a regular QAM, half of the constellation points can be deleted. Of the deleted points, half of them are at the center, which have lowest amplitudes, and another half are at the four corners, which have large amplitudes. In this way, a band of QAM constellation is created, as shown in FIG. 6 and FIG. 7, which are pruned from a 16 QAM and a 64 QAM. Interestingly, such a pruned QAM has the same average power per QAM as the original QAM.

It should also be emphasized that Gray coding is still applicable to pruned QAM, as illustrated in FIG. 6 and FIG. 7.

Another interesting property worth pointing out is that pruned QAM has more edge constellation points, which means higher LLRs. “Edge constellation points” refers to these points having fewer “neighbors”. Since each neighbor can limit the LLR value of one bit in the constellation point, fewer neighbors means the constellation points of the opposite bit-value will be far away, and thus higher LLRs. This can be easily observed from the inner-circle constellations in FIG. 7. Therefore, the impact of the “sacrificed” 1-bit is much smaller.

LLR refers to log-likelihood ratio.

It is also worth commenting that although 1-bit (that is, half points) pruning is used as an example, QAM pruning can also use 2-bits, for example pruning a 4096 QAM to a 1024 QAM in microwave communication. The pruning principle is still the same: half near the origin point, and half at the outer edges.

### Amplitude Distribution of a Pruned QAM

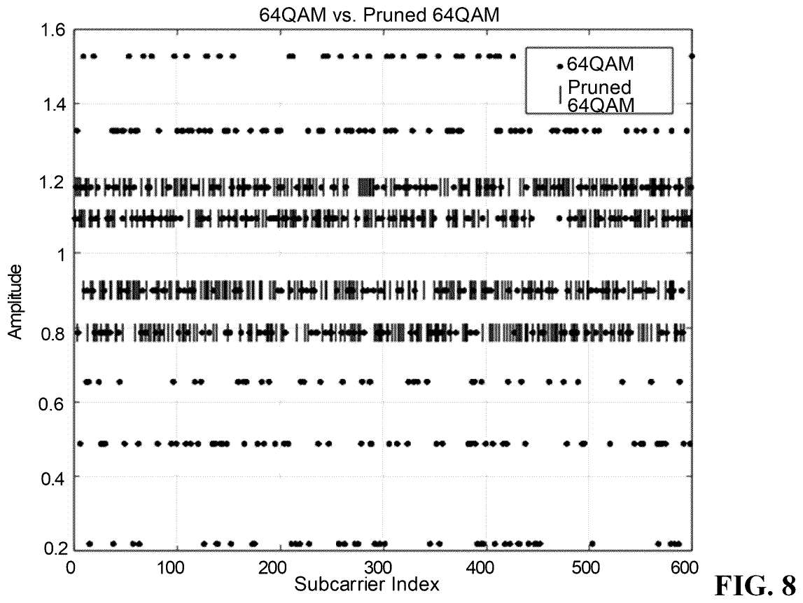

To show the narrowed amplitude range of a pruned QAM, FIG. 8 compares the amplitude of a pruned 64 QAM and a regular 64 QAM. The figure shows that the amplitude of a pruned 64 QAM concentrates in the middle of the original 64 QAM, and its lowest amplitude is about 12 dB higher than that in the original 64 QAM, which makes its sensing performance very similar to QPSK.

FIG. 8 uses dots and strokes to represent amplitudes for regular 64 QAM and pruned 64 QAM. It should be appreciated, however, that the strokes do not represent amplitude ranges. The strokes are intended only to differentiate between regular 64 QAM and pruned 64 QAM amplitudes in a manner such that both are visible. A pruned 64 QAM amplitude is at a midpoint of each stroke.

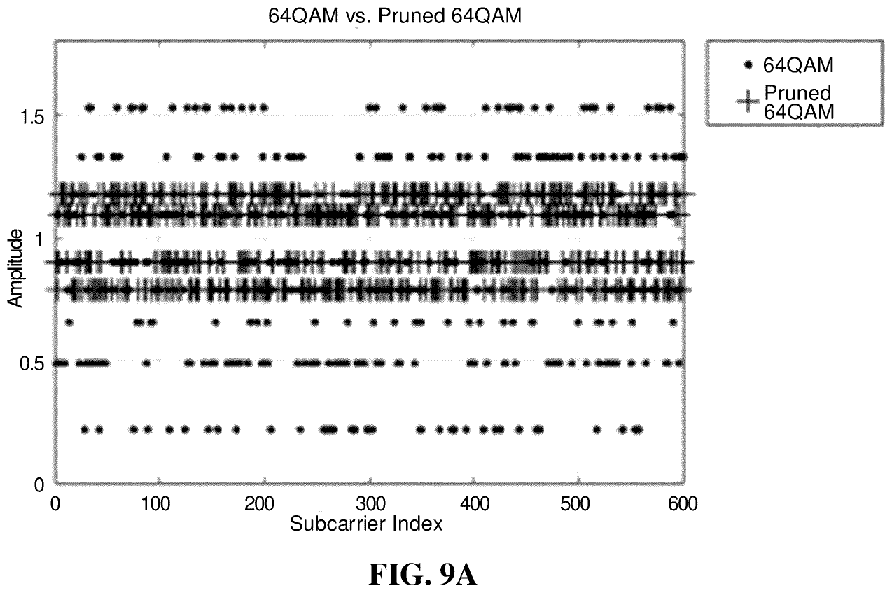

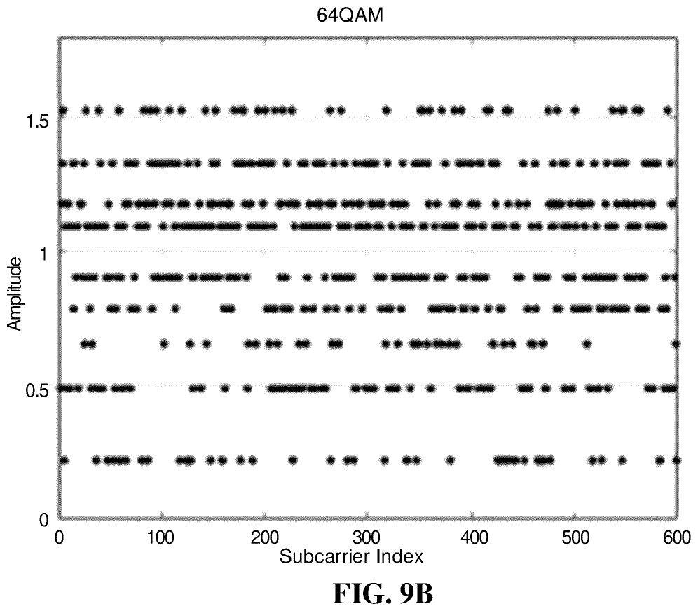

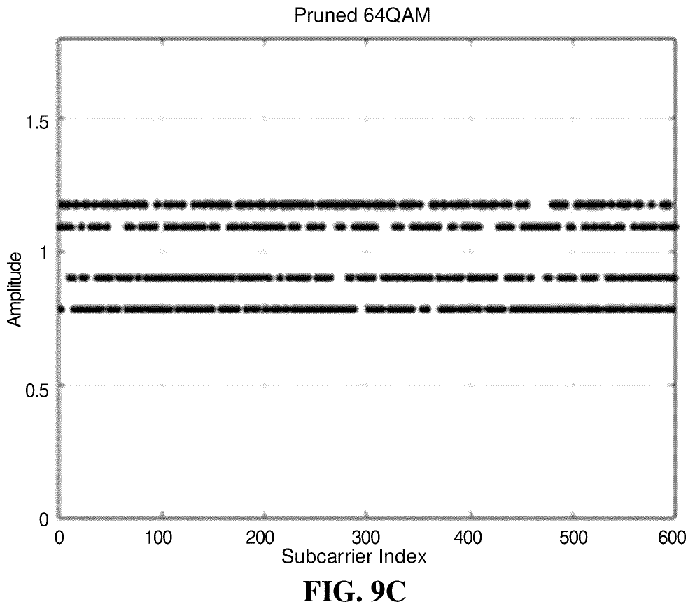

For greater certainty, FIGS. 9A-9C are presented to illustrate the same data. FIG. 9A is similar to FIG. 8, but uses a different symbol for the pruned 64 QAM amplitudes. FIGS. 9B and 9C represent the regular 64 QAM and pruned 64 QAM amplitudes in separate plots.

### PAPR Impact

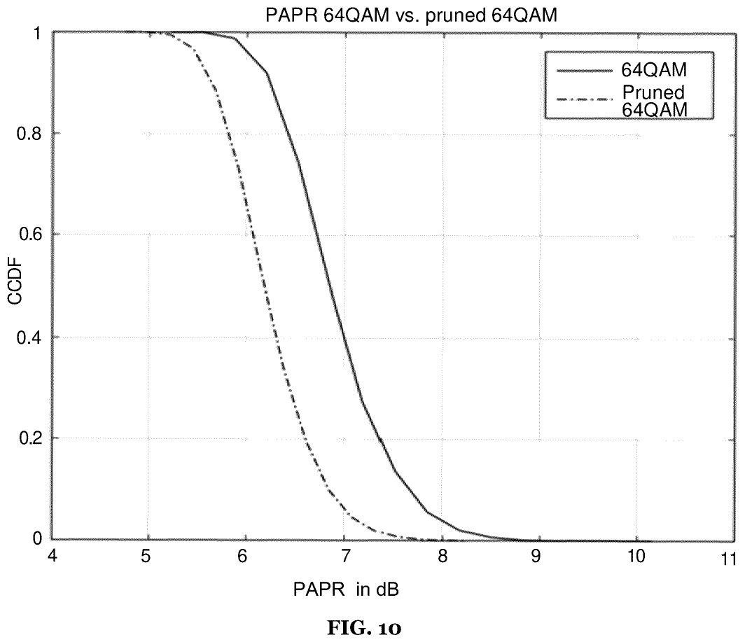

The PAPR of a QPSK SC-FDMA signal is smaller than that of a 64 QAM SC-FDMA signal; since a pruned 64 QAM has a reduced amplitude range, it is reasonable to expect the PAPR of a pruned 64 QAM SC-FDMA signal to have a lower PAPR than a 64 QAM SC-FDMA signal. This is illustrated by plotting the PAPRs of the two constellations in FIG. 10. As expected, pruned 64 QAM indeed has lower PAPR, although the difference is smaller than 1 dB.

PAPR refers to peak-to-average power ratio.

The example shown in FIG. 10 refers to 64 QAM and pruned 64 QAM. More generally, PAPR can be reduced by using pruned QAM in applications such as in single-carrier offset QAM (SC-OQAM) and single-carrier QAM (SC-QAM). Reduced PAPR may also be provided by using other types of pruned constellations, and is not in any way limited to QAM.

### Overview

The preceding examples used QAM as an example; however, pruning can be applied to any kind of constellations to make them 1) maintaining the properties of the original constellation, and 2) half of the pruned constellation points are near the origin point, while half at the outer edges of the original constellation.

In addition, OFDM-based ISAC and differential phase modulation are two examples listed in this application; however, pruned QAM can be applied to other applications where reduced amplitude dynamic range is required.

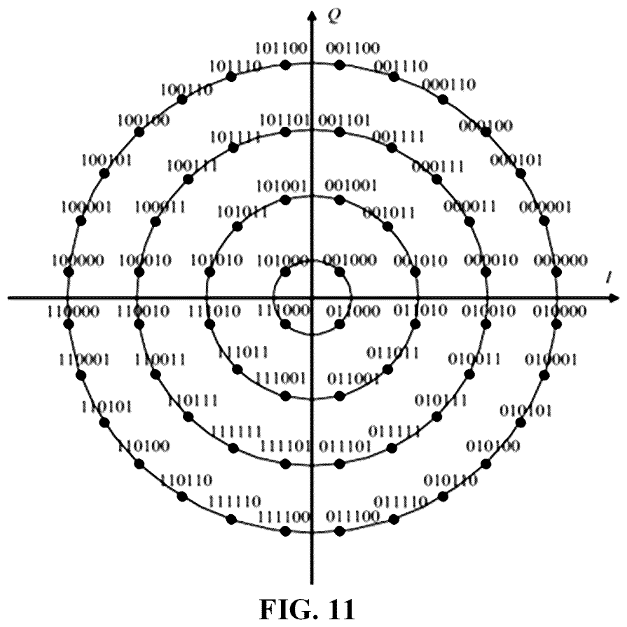

Regarding other constellations, FIG. 11 illustrates a 64-point amplitude and phase-shift keying (APSK) constellation. 6-bit input bit blocks or sequences that are mapped to constellation points in the constellation are also shown. A pruned constellation based on the 64-point constellation, but for 5-bit input bit blocks instead of 6-bit input bit blocks as shown, includes 32 (half) of the constellation points in the 64-point constellation. According to some embodiments disclosed herein, such a 32-point constellation may include constellation points in a band between the outermost and innermost rings in FIG. 11. The outermost ring includes 28 constellation points associated with highest power (farthest from the origin), and the innermost ring includes 4 constellation points associated with lowest power (closest to the origin). The remaining portion of the constellation includes 32 constellation points, and excludes the constellation points that are associated with highest power and lowest power in the 64-point constellation. Mapping of input bits blocks to modulated symbols using such a 32-point constellation based on the 64-point constellation may satisfy Gray coding.

FIG. 11 illustrates one example of another type of constellation to which features disclosed herein may be applied. The outer/inner ring pruning example described with reference to FIG. 11 also illustrates that pruning need not necessarily be evenly applied to higher power and lower power constellation points. Even pruning of higher power and lower power constellation points may help maintain substantially the same average power between a base constellation and a pruned constellation, but even if average power changes as a result of pruning, at least dynamic range of power associated with constellation points in a pruned constellation is smaller than dynamic range of power associated with constellation points in a base constellation.

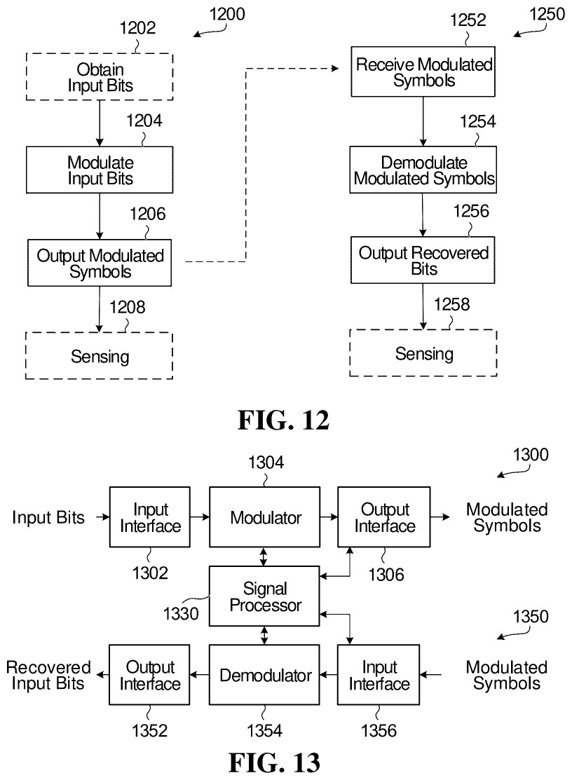

Various aspects of the present disclosure are described herein and shown in the drawings by way of example. FIG. 12 is a flow diagram illustrating more general example methods according to embodiments.

At the left, 1200 in FIG. 12 illustrates operations or features that may be provided or supported at a transmitter or transmit-side device, and at the right, 1250 illustrates operations or features that may be provided or supported at a receiver or receive-side device. Embodiments may involve either or both of such devices. A single device may provide or support both transmitter or transmit-side features and receiver or receive-side features.

With reference first to 1200, an operation of modulating input bits is shown at 1204. This may be referred to as modulating, mapping, or modulation mapping, for example. The operation at 1204 may be described as modulating, mapping, or modulation mapping input bits, based on a first constellation, to produce modulated symbols. This example refers to producing modulated symbols, but producing modulated symbols may also be described as generating modulated symbols, or producing or generating a modulated signal. Depending on the order of the modulation or mapping, blocks of input bits may include one or more input bits, and each block is mapped or modulated to produce or generate a respective modulated symbol. In general, binary digits may be taken as input (input bits) to produce or generate complex-valued modulation symbols as output.

For example, based on the constellation shown in FIG. 6, blocks of 3 input bits can be mapped to respective complex-valued modulation symbols. Based on the constellation shown in FIG. 7, blocks of 5 input bits can be mapped to respective complex-valued modulation symbols. Based on a pruned constellation that is consistent with part of the constellation shown in FIG. 11 (not including the outer and inner rings of constellation points for example), blocks of 5 input bits can be mapped to respective complex-valued modulation symbols.

Although the present disclosure refers primarily to modulation symbols, it should be appreciated that, in the context of constellations and constellation points, such modulation symbols are complex-valued modulation symbols.

The first constellation referenced above refers to a constellation that includes constellation points that are also consistent with a portion of another constellation. A first constellation may also be referred to as a pruned constellation, but it should be appreciated that not all embodiments necessarily involve specifically pruning a larger constellation. More generally, a first constellation can be consistent with a portion of a second constellation. That portion of the second constellation excludes at least some of the highest power constellation points and at least some of the lowest power constellation points of the second constellation. This may be described as the portion of the second constellation excluding a first subset of constellation points in the second constellation that are associated with lowest power and a second subset of constellation points in the second constellation that are associated with highest power. Power associated with constellation points increases as distance from the origin of the constellation increases. Thus, constellation points that are furthest from the origin of the constellation are associated with highest power and constellation points that are closest to the origin of the constellation are associated with lowest power. Power is referenced herein as an example of a characteristic or property that may vary between constellation points depending on their position in a constellation. Features that are disclosed herein with reference to power also apply to energy or amplitude, which also vary depending on position of constellation points in a constellation.

Consider the constellation shown in FIG. 6, which is consistent with the portion of a 16 QAM constellation excluding the 4 constellation points around the constellation origin (center) that are associated with lowest power, and also excluding the 4 constellation points at the outer corners, that are furthest from the constellation origin and are associated with highest power.

The example in FIG. 7 illustrates that a first constellation as shown may be consistent with a portion of a larger base constellation excluding a first subset of lowest power constellation points (around the origin of the constellation) and a second subset that includes the highest power constellation points (at the corners and adjacent edge points). In this example, the second subset also includes constellation points ((5,5), (−5,5), (−5,−5), (5,−5)), which are associated with lower power than some of the constellation points ((+/−3,+/−7), (+/−7, +/−3)) that remain in the constellation in FIG. 7. This illustrates that a higher-power subset of constellation points includes highest-power constellation points, not necessarily all of the constellation points in such a subset are associated with higher power than all of the constellation points in a reduced or pruned constellation. The (+/−5, +/−5) constellation point pruning that is inherent in the constellation example in FIG. 7 provides for a more symmetric pruned or reduced constellation than if the (+/−5, +/−5) constellation points were to remain and 4 of the ((+/−3,+/−7), (+/−7, +/−3)) constellation points were to be pruned.

With reference to FIG. 11 and the above example of a pruned constellation that does not include the constellation points in the inner and outer rings, a first subset of constellation points associated with lowest power includes the constellation points in the inner ring, and a second subset of constellation points associated with highest power includes the constellation points in the outer ring.

These examples illustrate how a first constellation may be consistent with a portion of a second constellation that excludes a first subset of constellation points in the second constellation that are associated with lowest power and a second subset of constellation points in the second constellation that are associated with highest power. This may be described in other ways, such as pruning from or not including constellation points from two parts or regions (highest or higher power and lowest or lower power) of a constellation, or a first constellation including only constellation points from a band of constellation points in a larger second constellation that also includes constellation points both inside (toward or closer to the constellation origin, associated with lower power) and outside (away or further from the constellation origin, associated with higher power). It may also be said that subsets of constellation points in a second constellation that are not included in a pruned first constellation include both constellation points associated with lower power and constellation points associated with higher power that those in the first constellation.

It is intended that all of these expressions or characterizations of first and second constellations are conveyed by describing a first constellation as being consistent with a portion of a second constellation. The foregoing expressions or characterizations are examples of how a first constellation may be consistent with a portion of a second constellation.

FIG. 12 illustrates outputting modulated symbols at 1206, and the modulated symbols may be transmitted as illustrated by the dashed line from 1206 to 1252. For example, modulated symbols produced at 1204 may be output at 1206 for further processing or handling, and in some embodiments may be transmitted as shown by the dashed line. The modulated symbols may be output to memory, for example, without necessarily also transmitting the modulated symbols. Modulating and transmitting may be performed or supported by different components, such as a modulator and a transmitter.

Regarding constellation points that are in a base constellation but not in a pruned constellation (which may also be referred to as a reduced or reduced size constellation), in some embodiments there are an equal number of higher power constellation points and lower power constellation points that are not included in a pruned constellation. For example, as described above, by sacrificing 1-bit from a regular QAM, half of the constellation points can be deleted, and of the deleted points, half of them are at the center, which have lowest amplitudes, and another half are at the four corners, which have large amplitudes. In the context of another more general example herein, in which a first constellation is consistent with a portion of a second constellation, the concept of an equal number of higher power and lower power constellation points may be described as the above-referenced first subset of constellation points and second subset of constellation points including an equal number of constellation points. This is shown by way of example if FIGS. 6 and 7, in which the first subset of constellation points in the second constellation (associated with lowest power and not part of the first constellation) includes 4 points in FIG. 6 and 16 points in FIG. 7, and the second subset of constellation points in the second constellation (associated with highest power and not part of the first constellation) also includes 4 points at the outer corners in FIG. 6 and 16 points at the outer corners (4 at each corner) in FIG. 7.

In other embodiments there the number of higher power constellation points and the number of lower power constellation points that are not included in a pruned constellation are not equal. An example described above with reference to FIG. 11 is illustrative of such an embodiment. In FIG. 11, the inner ring includes the 4 constellation points associated with lowest power, and the outer ring includes 28 constellation points associated with highest power. If the constellation points in these rings are not included in a pruned constellation, then the number of excluded higher power points is clearly different from the number of excluded lower power points. In the context of another example herein, in which a first constellation is consistent with a portion of a second constellation, the concept of unequal numbers of higher power and lower power constellation points may be described as a number of constellation points in the above-referenced first subset of constellation points being different from a number of constellation points in the above-referenced second subset of constellation points.

Average power may stay the same, or substantially the same, between a base constellation and a pruned constellation. Equal numbers of excluded higher power and lower power constellation points, for example, may help maintain the same overall average power for a pruned constellation as for the base constellation. For example, average power associated with constellation points in the above-referenced first constellation may be substantially the same as average power associated with all constellation points in the above-referenced second constellation.

When constellation points near the origin of a constellation are pruned, zero-forcing effects are mitigated; when constellation points at the outer edges are to be pruned, the quality of communication is to be maintained. Pruning constellation points near the origin can mitigate the noise enhancement effect in sensing, but increase the average power of the pruned constellation; pruning points at the outer edges, however, can reduce the average power of the pruned constellation, which is helpful in mitigating the pruning impact to communication.

The purpose of maintaining substantially the same power is to maintain the quality of communication. If pruning would result in higher average power, then to have the same or similar average power after pruning, a scaling factor having a value of less than one would be applied to the pruned constellation, which reduces the Euclidean distance between neighboring constellation points. Maintaining the average power of a pruned constellation to be substantially the same as that of a base constellation without such scaling also maintains the Euclidean distances between neighboring constellation points substantially the same, so as to minimize the impact to communication.

For example, it may be preferable to maintain average power of a pruned constellation to be no more than 10% larger than the average power of the base constellation. In this example, average power being substantially the same means that average power associated with constellation points in a pruned constellation is no more than 10% larger than average power associated with all constellation points in a base constellation.

There may also be a preferred power change limit for a reduction in average power. An average power reduction limit may be the same as an average power increase limit, such as 10% for example. With this example limit (10%) for both an increase and reduction in average power, substantially the same means that average power associated with constellation points in a pruned constellation is no more than 10% larger and no more than 10% smaller than average power associated with all constellation points in a base constellation. In other words, substantially the same in this example means that average power associated with constellation points in a pruned constellation is within 10% of average power associated with all constellation points in a base constellation, or average power associated with constellation points in a pruned constellation is average power associated with all constellation points in a base constellation plus or minus 10%.

Substantially the same average power, with or without specific limits, which may be relative limits (percentages in the above example) or absolute limits, on an increase and/or a decrease in power, may be provided in some embodiments but not necessarily in all embodiments. In QAM constellations, for example, in pruning half of the constellation points from a base constellation, half of the pruned constellation points can be pruned from around the origin and half of the pruned constellation points can be pruned from the outer corners. With unequal pruning and more higher power than lower power points (or more lower power points than higher power points being pruned from a constellation, average power may change more significantly as a result of pruning.

In the example described above with reference to FIG. 11 and excluding constellation points in the inner ring and the outer ring from a pruned constellation, average power of the pruned constellation will be lower because more of the highest power constellation points (in the outer ring) are excluded from the pruned constellation. If substantially the same average power is to be maintained, then all of the highest power constellation points in the outer ring might not be excluded from the pruned constellation. For example, some of the highest power constellation points may be included in the pruned constellation, and more of the lower power constellation points (in the second innermost ring, for example) may be excluded. The resultant pruned constellation would then have higher average power than a pruned constellation that does not include any of the outer ring constellation points.

Regardless of whether average power is substantially the same for a base constellation and a pruned constellation, the dynamic range of power associated with constellation points in the pruned constellation is smaller than the dynamic range of power associated with constellation points in the second constellation. This is illustrated perhaps most clearly in FIGS. 8-9C. In the context of the above-referenced first and second constellations, this dynamic range characteristic or property may be described as dynamic range of power associated with constellation points in the first constellation being smaller than dynamic range of power associated with all constellation points in the second constellation, or equivalently as dynamic range of power associated with all constellation points in the second constellation being larger than dynamic range of power associated with constellation points in the first constellation.

Reference is made herein to sacrificing one or more bits. A base constellation includes more constellation points than a pruned constellation, and accordingly larger blocks of input bits can be mapped to modulated symbols using a base constellation. FIG. 6, for example, illustrates an 8-point constellation derived from 16 QAM. The base constellation in this example includes 16 constellation points, and 4-bit blocks can be mapped to one of 16 modulation symbols based on that constellation. The pruned 8-point constellation includes only 8 points, and 3-bit blocks can be mapped based on the pruned constellation. In this example, modulation or mapping based on the pruned constellation is for 3-bit blocks of input bits, compared to 4-bit blocks for the base constellation, and this illustrates a “sacrifice” of 1 bit. FIG. 7, and the examples of pruning the 64-point constellation in FIG. 11 to 32 points, further illustrate a 1-bit sacrifice between 6-bit block modulation or mapping for a base constellation and 5-bit block modulation or mapping for a pruned 32-point constellation.

In the context of the above-referenced first and second constellations, this may be described as a number of input bits mapped to each of the modulated symbols based on the first constellation being less than a number of input bits associated with the second constellation, or equivalently as a number of input bits associated with the second constellation being greater than a number of input bits mapped to each of the modulated symbols based on the first constellation being less than. Put another way, input bit blocks for modulation or mapping, or input bit blocks corresponding to modulated symbols, are shorter (or smaller, or include less or fewer of the input bits) for a pruned constellation than for a base constellation, or equivalently input bit blocks for modulation or mapping, or input bit blocks corresponding to modulated symbols, are longer (or larger, or include more input bits) for a base constellation than for a pruned constellation.

A method may involve obtaining a pruned constellation for modulation or mapping at 1204. The pruned constellation may be obtained in any of various ways, including the examples below. The following examples are in the context of the above-referenced first and second constellations and subsets, but apply more generally to a pruned constellation and a base constellation.

In some embodiments, obtaining a pruned constellation involve pruning constellation points from a base constellation. For example, a method may involve pruning the above-referenced first subset of constellation points and the above-referenced second subset of constellation points from the above-referenced second constellation to obtain the first constellation.

Another possible option for obtaining a pruned constellation involves selecting constellation points from a base constellation that are to be included in the pruned constellation. Pruning involves removing excluded constellation points that are not to be included in the pruned constellation, whereas selecting in this example involves selecting the constellation points that are to be included. Therefore, obtaining the above-referenced first constellation may involve selecting, from the above-referenced second constellation, constellation points other than the above-referenced first subset of constellation points and the above-referenced second subset of constellation points.

These examples of obtaining a pruned constellation involve obtaining the pruned constellation by generating or producing the pruned constellation by removing (pruning) or selecting constellation points from a base constellation. This may be done in advance, or otherwise separately from the modulation or mapping at 1204. It should therefore be appreciated that not all embodiments involve obtaining a pruned constellation by pruning, selecting, or otherwise modifying a base constellation.

For example, a constellation may be specified or defined and stored in memory, in which case obtaining the constellation may involve accessing information stored in memory that specifies or defines the constellation. Such information may be in the form of a table that indicates input bit blocks and corresponding modulation symbols to which each input bit block is mapped, to produce modulation symbols for output. Another form in which a constellation or mapping based on a constellation may be specified or defined is an equation or formula that takes one or more bits as input and produces corresponding modulation symbols for output. In this case, information about the equation or formula may be stored in memory, and obtaining a constellation may involve accessing that information in memory. Input bits can then be processes according to the equation or formula to map the input bits and produce modulates symbols.

Information that specifies or defines a constellation (using a table, equation, or formula in these examples) may be set out in a communications standard or specification for example. Such information may be stored locally at a device that is to provide or support modulation, and/or demodulation. Local storage of such information avoids generation or regeneration of a pruned constellation by a device.

A communications standard or specification may also or instead be involved in embodiments in which a pruned constellation is generated (by pruning or selecting constellation points for example) from a base constellation. For example, such a standard or specification may indicate a base constellation from which a pruned constellation is to be generated, and instructions as to how constellation points in the base constellation are to be pruned or selected, or how the base constellation is otherwise to be modified, to generate the pruned constellation.

As described at least above, Gray coding is still applicable to pruned QAM, and this is illustrated by way of example in FIGS. 6 and 7. This is another characteristic or property that may apply to other constellations. More generally, mapping of input bits to modulated symbols may satisfy Gray coding. Input bit blocks may be assigned or allocated to modulated symbols in a pruned constellation accordingly.

This Gray coding characteristic or property may be described as the input bits being mapped (based on a pruned constellation) such that input bits that are mapped to adjacent modulated symbols satisfy Gray coding.

Embodiments may provide or support other features, and several examples are included in FIG. 12. In some embodiments, obtaining input bits as shown at 1202 in FIG. 12, may be performed or supported separately from the modulating or mapping at 1204 and/or the outputting at 1206. The input bits may be or include data from different devices and/or data associated with different services, for example. Obtaining the input bits at 1202 may involve any of various operations, such as any one or more of the following: collecting or otherwise receiving data outputs from one or more devices and/or services; accessing data in a memory; segmenting or otherwise pre-processing data before encoding.

Sensing is shown in FIG. 12 at 1208 as another example of a feature that may be provided in some embodiments. As described above, low amplitude sensing signals can cause significant noise enhancement in ISAC. Therefore, a pruned constellation that does not include lowest power constellation points from a base constellation may be useful in sensing.

There are two different modes or types of ISAC: monostatic and bistatic. In monostatic sensing, sensing is performed by the transmitting device. When the transmitting device receives a signal based on a transmitted signal that it has transmitted, sensing information can be obtained by removing the transmitted signal from the received signal. The received signal may be a reflected signal (a reflection of the transmitted signal) or a signal that is transmitted to the transmitting device by another device in response to the transmitted signal, for example. These are both examples of signals that may be received by a transmitting device and are based on a transmitted signal that is transmitted by the transmitting device. Such a received signal may be referred to as a return signal or a sensing signal, for example.

In this type of sensing, the transmitting device knows what it has transmitted, and therefore the transmitted signal does not need to be recovered. The transmitted signal and the received signal can be used by the transmitting device for sensing at 1208.

In an embodiment, the modulated symbols produced at 1204 are transmitted, and transmitting may involve transmitting a signal that includes, in some form, the modulated signals or transformed versions of those symbols. The sensing at 1208 may then involve receiving a return signal that is based on the transmitted signal, and removing the transmitted signal from the return signal to obtain sensing information. The following examples of how a transmitted signal may be removed from a return signal are provided elsewhere herein: dividing the return signal by the transmitted signal; multiplying the return signal by a conjugate of the transmitted signal in frequency domain. Either or both of these examples may be provided or supported for the sensing at 1208.

Another example of features that may be provided in some embodiments is but are not explicitly shown in FIG. 12 relates to signaling. Some embodiments may involve transmitting and/or receiving signaling or any of various types of indications. More generally, embodiments may involve communicating, in a wireless communication network, signaling indicative of any of various parameters. Parameters related to one or more of modulation/mapping, encoding, transmission, reception, decoding, or demodulation may be indicated in signaling.

Such communicating of signaling may involve transmitting the signaling by a modulator/modulation device or a transmitter/transmitting device that is to transmit modulated symbols, to a demodulator/demodulation device or a receiver/receiving device. The communicating may also or instead involve receiving the signaling by a demodulator/demodulation device or a receiver/receiving device from a modulator/modulation device or a transmitter/transmitting device. Signaling need not necessarily be between, or only between, communication devices by which modulated symbols are to be transmitted or received. For example, a network device such as a gNB or a base station may transmit signaling to configure parameters at one or more communication devices. Therefore, a method may involve a network device transmitting signaling, and a modulator/modulation device or a transmitter/transmitting device receiving the signaling from the network device, and/or a demodulator/demodulation device or a receiver/receiving device receiving the signaling from the network device.

At 1250, FIG. 12 illustrates various decoding and/or receiving counterparts of the features shown at 1200. From a receiving device perspective, the receiving at 1252 represents receiving modulated symbols. Demodulating the modulated symbols is shown at 1254, and involves demodulating the modulated symbols based on a pruned constellation (also referred to herein as a first constellation), to recover input bits. As in an example above, the first constellation includes constellation points that are consistent with a portion of a second constellation. That portion of the second constellation excludes a first subset of constellation points in the second constellation that are associated with lowest power and a second subset of constellation points in the second constellation that are associated with highest power. FIG. 12 also illustrates outputting the recovered bits at 1256, for further processing for example.

Embodiments related to receiving and/or decoding may include other features, such as any one or more of the following features, for example, which are also discussed elsewhere herein:
there may be an equal number of excluded higher power and lower power constellation points;
for example, the first subset of constellation points and the second subset of constellation points may include an equal number of constellation points;
the numbers of excluded higher power and lower power constellation points may be different;
for example, a number of constellation points in the first subset of constellation points may be different from a number of constellation points in the second subset of constellation points;
average power may be substantially the same between a pruned constellation and a base constellation;
for example, average power associated with constellation points in the first constellation may be substantially the same as average power associated with all constellation points in the second constellation;
dynamic range of power may be lower or smaller for a pruned constellation than for a base constellation (or equivalently, dynamic range of power may be higher or larger for a base constellation than for a pruned constellation);
for example, dynamic range of power associated with constellation points in the first constellation may be smaller than dynamic range of power associated with all constellation points in the second constellation, or equivalently dynamic range of power associated with all constellation points in the second constellation may be larger than dynamic range of power associated with constellation points in the first constellation;
input bit blocks that are mapped for a pruned constellation may be shorter than those for a base constellation;
for example, a number of the input bits recovered from each of the modulated symbols based on the first constellation may be less than a number of input bits associated with the second constellation;
obtaining a pruned constellation may involve pruning a base constellation;
for example, a method may involve pruning the first subset of constellation points and the second subset of constellation points from the second constellation to obtain the first constellation;
obtaining a pruned constellation may involve selecting constellation points from a base constellation;
for example, a method may involve obtaining the first constellation by selecting, from the second constellation, constellation points other than the first subset of constellation points and the second subset of constellation points;
examples of other ways in which a pruned constellation may be obtained are provided elsewhere herein, and may be implemented in receive-side embodiments; Gray coding may be supported or satisfied in some embodiments;
for example, the input bits may be mapped (based on the first constellation) such that input bits that are mapped to adjacent modulated symbols satisfy Gray coding;
sensing may be supported in some embodiments, as shown at 1258 in FIG. 12;
for example, at 1258 a signal based on a signal that is received at 1252 may be returned to a transmitting device, to support sensing operations at the transmitting device-although 1258 illustrates an example in which received modulated symbols are also demodulated at 1254, in some embodiments a receiving device may return a signal to a transmitting device at 1258 without necessarily demodulating received symbols;
in bistatic sensing, for example, a receiving device may receive a signal and recover sensing information by removing a transmitted signal-in this case the transmitted signal is first determined so that the sensing information can be recovered;
for example, the receiving at 1252 may involve receiving a signal, and a method may include determining a transmitted signal based on the modulated symbols, and removing the transmitted signal from the received signal to obtain sensing information-such determining and removing are illustrative of operations that may be involved in sensing at 1258;
the removing may involve, for example, dividing the received signal by the transmitted signal, or multiplying the received signal by a conjugate of the transmitted signal in frequency domain.

A method related to receiving and/or demodulating symbols may also provide or support other features, such as counterparts of features described herein in the context of methods related to modulating and/or transmitting symbols.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 4, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to, or a processor, device, or other component may otherwise be configured to: map input bits, based on a pruned constellation (also referred to herein as a first constellation), to produce modulated symbols; and output the modulated symbols. Programming stored in or on a non-transitory computer readable storage medium may also or instead include instructions to or to cause a processor to, or a processor, device, or other component may otherwise be configured to: receive modulated symbols and demodulate the modulated symbols, based on a pruned constellation (also referred to herein as a first constellation), to recover input bits.

Apparatus embodiments are not limited to the foregoing examples, or to processor-based or programming-based embodiments. An apparatus may also or instead include, for example, a modulator for mapping input bits based on a first constellation to produce modulated symbols, and an interface, coupled to the modulator, for outputting the modulated symbols. An apparatus may also or instead include an interface for receiving modulated symbols and a demodulator, coupled to the interface, for demodulating the modulated symbols to recover input bits.

FIG. 13 is a block diagram illustrating an apparatus according to an embodiment. At 1300, FIG. 13 illustrates components of an example apparatus in which or in conjunction with which transmitting and/or modulation features may be implemented, and components of an example apparatus in which or in conjunction with which receiving and/or demodulation features may be implemented are illustrated at 1350. A signal processor 1330 may be provided in either of these types of apparatus. In some embodiments, an apparatus may include both transmitting and receiving features, and either or both of modulation features or demodulation features. In the example shown in FIG. 13, an apparatus with all of the illustrated components supports both modulation features and demodulation features, as well and transmitting features and receiving features.

For modulation features and transmitting features, the example apparatus in FIG. 13 includes an input interface 1302, a modulator 1304 coupled to the input interface, an output interface 1306, and a signal processor 1330 coupled to the modulator and the output interface. Input bits for modulation are shown as inputs to the input interface 1302, and modulated symbols are shown as outputs from the output interface 1306. Although shown as a separate component in FIG. 13, the output interface 1306 for outputting symbols may be provided by, incorporated into, or coupled to the modulator 1304. Similarly, although shown as a separate input interface 1302 in FIG. 13, an interface through which input bits for modulation are obtained by the modulator 1304 may be provided by, incorporated into, or coupled to the modulator.

Modulation-side or transmit-side features or functions, and other features or functions herein, may be implemented in any of various ways, such as in hardware, firmware, or one or more components that execute software. The present disclosure is not limited to any specific type of implementation, and implementation details may vary between different devices.

Input bits may be obtained, and symbols may be output, via any of various types of interface, including a communication interface in the case of transmitting codewords or receiving input bits for modulation. Embodiments are not in any way restricted to any particular type of interface, the implementation of which may be based at least in part on how input bits are to be obtained and how symbols are to be output.

In an embodiment, an apparatus includes a modulator such as the encoder 1304 for mapping input bits, based on a first constellation, to produce modulated symbols. An interface may be provided and coupled to the modulator, and in the example shown the output interface 1306 is coupled to the modulator 1304 for outputting the symbols. As in another example described at least above, the first constellation includes constellation points that are consistent with a portion of a second constellation, and the portion of the second constellation excludes a first subset of constellation points in the second constellation that are associated with lowest power and a second subset of constellation points in the second constellation that are associated with highest power.

More generally, an apparatus or a component thereof such as a modulator 1304 or a processor may be configured to map (or for mapping) input bits based on a first constellation to produce modulated symbols. An apparatus or a component thereof such as an interface 1306, which may be coupled to the modulator 1304, may be configured to output (or for outputting), or programming may include instructions to output (or for outputting) or to cause a processor to output, the symbols as disclosed herein.

Embodiments related to such apparatus or non-transitory computer readable storage media may include any one or more of the following features, for example, which are also discussed elsewhere herein:
there may be an equal number of excluded higher power and lower power constellation points;
for example, the first subset of constellation points and the second subset of constellation points may include an equal number of constellation points;
the numbers of excluded higher power and lower power constellation points may be different;
for example, a number of constellation points in the first subset of constellation points may be different from a number of constellation points in the second subset of constellation points;
average power may be substantially the same between a pruned constellation and a base constellation;
for example, average power associated with constellation points in the first constellation may be substantially the same as average power associated with all constellation points in the second constellation;
dynamic range of power may be lower or smaller for a pruned constellation than for a base constellation (or equivalently, dynamic range of power may be higher or larger for a base constellation than for a pruned constellation);
for example, dynamic range of power associated with constellation points in the first constellation may be smaller than dynamic range of power associated with all constellation points in the second constellation, or equivalently dynamic range of power associated with all constellation points in the second constellation may be larger than dynamic range of power associated with constellation points in the first constellation;
input bit blocks that are mapped for a pruned constellation may be shorter than those for a base constellation;
for example, a number of the input bits recovered from each of the modulated symbols based on the first constellation may be less than a number of input bits associated with the second constellation;
obtaining a pruned constellation may involve pruning a base constellation;
for example, the apparatus or a component thereof such as the modulator 1304 or the signal processor 1330 may be configured to prune (or for pruning), or programming may include instructions to prune (or for pruning), or to cause a processor to prune the first subset of constellation points and the second subset of constellation points from the second constellation to obtain the first constellation;
obtaining a pruned constellation may involve selecting constellation points from a base constellation;
for example, the apparatus or a component thereof such as the modulator 1304 or the signal processor 1330 may be configured to obtain (or for obtaining), or programming may include instructions to obtain (or for obtaining), or to cause a processor to obtain the first constellation by selecting, from the second constellation, constellation points other than the first subset of constellation points and the second subset of constellation points;
examples of other ways in which a pruned constellation may be obtained are provided elsewhere herein, and may be implemented in apparatus embodiments;
Gray coding may be supported or satisfied in some embodiments;
for example, the input bits may be mapped (based on the first constellation) such that input bits that are mapped to adjacent modulated symbols satisfy Gray coding;
the apparatus or a component thereof such as the interface 1306 may be configured to transmit (or for transmitting), or programming may include instructions to transmit (or for transmitting), or to cause a processor to transmit the modulated symbols;
sensing may be supported in some embodiments;
for example, embodiments in which the modulated symbols are transmitted may involve transmitting a signal, in which case the apparatus or a component thereof such as the interface 1356 may be configured to receive (or for receiving), or programming may include instructions to receive (or for receiving), or to cause a processor to receive a return signal that is based on the transmitted signal;
the apparatus or a component thereof such as the signal processor 1330 may be configured to remove (or for removing), or programming may include instructions to remove (or for removing), or to cause a processor to remove the transmitted signal from the return signal to obtain sensing information;
the removing may involve, for example, dividing the received signal by the transmitted signal, or multiplying the received signal by a conjugate of the transmitted signal in frequency domain.

With reference again to FIG. 13, the example apparatus also includes components to provide or support receiving and demodulation features. These components may be provided separately in a demodulation or receiving device, or together with other components to provide or support demodulation or receiving features together with modulation or transmitting features.

An input interface 1356 is coupled to a demodulator 1354, and these components are also coupled to the signal processor 1330. The demodulator 1354 is coupled to an output interface 1352. Recovered input bits are shown as an output from the output interface 1352, and modulated symbols are shown as inputs received by the interface 1356. The interface 1356 may be provided by, incorporated into, or coupled to the demodulator 1354, and similarly an interface through which recovered bits are output by the demodulator may be provided by, incorporated into, or coupled to the decoder.

Demodulation-side or receive-side features or functions, and other features or functions herein, may be implemented in any of various ways, such as in hardware, firmware, or one or more components that execute software. The present disclosure is not limited to any specific type of implementation, and implementation details may vary between different devices, for example.

Modulated symbols may be received or otherwise obtained, and recovered bits may be output, via any of various types of interface, including a communication interface in the case of receiving symbols or transmitting recovered bits. Embodiments are not in any way restricted to any particular type of receiver or interface, the implementation of which may be based at least in part on how symbols for demodulation are to be obtained and how recovered bits are to be output. Modulator and demodulator interfaces are shown separately in FIG. 13 to illustrate that modulation and demodulation features may be implemented independently. However, it should be appreciated that a single device or equipment may support both modulation and demodulation, in which case a modulator and a demodulator may be coupled to the same interface(s) at 1302, 1352. For example, the modulator 1304 and the demodulator 1354 may be coupled to the same interface(s) to obtain input bits for modulation by the modulator and to output bits that are recovered by the demodulator. The modulator 1304 and the demodulator 1354 may also or instead be coupled to the same interface(s) to output symbols that are produced by the modulator and receive symbols for demodulation by the demodulator.

In an embodiment, an apparatus includes a demodulator such as the demodulator 1354 for demodulating received symbols. The interface 1356 is coupled to the demodulator, for receiving the symbols as disclosed herein. An apparatus may also include an interface such as the output interface 1352 in some embodiments, for outputting recovered bits. More generally, an apparatus or a component thereof such as a demodulator 1354 or a processor may be configured to demodulate (or for demodulating) symbols, or programming may include instructions to demodulate (or for demodulating) symbols. An apparatus or a component thereof such as an interface 1356 coupled to the demodulator 1354, may be configured to receive (or for receiving) or to otherwise obtain (or for obtaining), or programming may include instructions to receive (or for receiving) or to otherwise obtain (or for obtaining) or to cause a processor to receive or otherwise obtain, the symbols. Receiving may involve receiving the symbols from a first communication device by a second communication device in a wireless communication network for example.

Embodiments related to such apparatus or non-transitory computer readable storage media may include any one or more of the following features, for example, which are also discussed elsewhere herein:
there may be an equal number of excluded higher power and lower power constellation points;
for example, the first subset of constellation points and the second subset of constellation points may include an equal number of constellation points;
the numbers of excluded higher power and lower power constellation points may be different;
for example, a number of constellation points in the first subset of constellation points may be different from a number of constellation points in the second subset of constellation points;
average power may be substantially the same between a pruned constellation and a base constellation;
for example, average power associated with constellation points in the first constellation may be substantially the same as average power associated with all constellation points in the second constellation;
dynamic range of power may be lower or smaller for a pruned constellation than for a base constellation (or equivalently, dynamic range of power may be higher or larger for a base constellation than for a pruned constellation);
for example, dynamic range of power associated with constellation points in the first constellation may be smaller than dynamic range of power associated with all constellation points in the second constellation, or equivalently dynamic range of power associated with all constellation points in the second constellation may be larger than dynamic range of power associated with constellation points in the first constellation;
input bit blocks that are mapped for a pruned constellation may be shorter than those for a base constellation;
for example, a number of the input bits recovered from each of the modulated symbols based on the first constellation may be less than a number of input bits associated with the second constellation;
obtaining a pruned constellation may involve pruning a base constellation;
for example, the apparatus or a component thereof such as the demodulator 1354 or the signal processor 1330 may be configured to prune (or for pruning), or programming may include instructions to prune (or for pruning), or to cause a processor to prune the first subset of constellation points and the second subset of constellation points from the second constellation to obtain the first constellation;
obtaining a pruned constellation may involve selecting constellation points from a base constellation;
for example, the apparatus or a component thereof such as the demodulator 1354 or the signal processor 1330 may be configured to obtain (or for obtaining), or programming may include instructions to obtain (or for obtaining), or to cause a processor to obtain the first constellation by selecting, from the second constellation, constellation points other than the first subset of constellation points and the second subset of constellation points;
examples of other ways in which a pruned constellation may be obtained are provided elsewhere herein, and may be implemented in apparatus embodiments;
Gray coding may be supported or satisfied in some embodiments;
for example, the input bits may be mapped (based on the first constellation) such that input bits that are mapped to adjacent modulated symbols satisfy Gray coding;
sensing may be supported in some embodiments;
for example, the apparatus or a component thereof such as the interface 1356, the signal processor 1330, or a transmitter may be configured to return or transmit (or for returning or transmitting), or programming may include instructions to return or transmit (or for returning or transmitting), or to cause a processor to return or transmit to a transmitting device a signal based on a signal that is received, to support sensing operations at the transmitting device—this may or may not involve demodulating received modulated symbols, because in some embodiments a receiving device may return a signal to a transmitting device without necessarily demodulating received symbols;
in bistatic sensing, for example, a receiving device may receive a signal and recover sensing information by removing a transmitted signal-in this case the transmitted signal is first determined so that the sensing information can be recovered;
for example, receiving modulated symbols may involve receiving a signal, and the apparatus or a component thereof such as the demodulator 1354 or the signal processor 1330 may be configured to determine (or for determining), or programming may include instructions to determine (or for determining), or to cause a processor to determine a transmitted signal based on the modulated symbols, and remove the transmitted signal from the received signal to obtain sensing information;
the apparatus or a component thereof such as the demodulator 1354 or the signal processor 1330 may be configured to remove (or for removing), or programming may include instructions to remove (or for removing), or to cause a processor to remove the transmitted signal from the received signal by, for example, dividing the received signal by the transmitted signal, or multiplying the received signal by a conjugate of the transmitted signal in frequency domain.

Other features disclosed herein may also or instead be provided or supported in apparatus embodiments.

Apparatus embodiments are not in any way restricted to single devices. A system, for example, may include a first communication device and a second communication device. The first communication device may be configured to map input bits, based on a first constellation, to produce a plurality of modulated symbols, and to transmit the modulated symbols. The second communication device may be configured to receive the modulated symbols and to demodulate the modulated symbols to recover the input bits. The first constellation includes constellation points that are consistent with a portion of a second constellation. That portion of the second constellation excludes a first subset of constellation points in the second constellation that are associated with lowest power and a second subset of constellation points in the second constellation that are associated with highest power.

More generally, other features disclosed herein may also or instead be provided in method, apparatus, and/or system embodiments.

The following acronyms, abbreviations, and initialisms may be used herein:

| | Acronym/Abbreviation/ |
|---|---|
| Full Name | Initialism |
| Integrated Sensing and Communication | ISAC |
| Quadrature Amplitude Modulation | QAM |
| Demodulation Reference Signal | DM-RS |
| Phase Tracking Reference Signal | PT-RS |
| Single-Carrier FDMA (also known as DFT- | SC-FDMA |
| s-OFDM) | |
| Inter-Symbol Interference | ISI |
| Differential Phase Shift Keying | DPSK |
| Log-Likelihood Ratio | LLR |
| DFT-spread OFDM | DFT-s-OFDM |

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
mapping input bits, based on a first constellation, to obtain a plurality of modulated symbols; and
outputting the modulated symbols,
wherein the first constellation comprises constellation points that are consistent with a portion of a second constellation, and
the portion of the second constellation excludes a first subset of constellation points in the second constellation that are associated with lowest power and a second subset of constellation points in the second constellation that are associated with highest power.

2. The method of claim 1, wherein a dynamic range of power associated with constellation points in the first constellation is smaller than a dynamic range of power associated with all constellation points in the second constellation.

3. The method of claim 1, wherein a number of the input bits mapped to each of the modulated symbols based on the first constellation is less than a number of input bits associated with the second constellation.

4. The method of claim 1, further comprising:
pruning the first subset of constellation points and the second subset of constellation points from the second constellation to obtain the first constellation.

5. The method of claim 1, further comprising:
obtaining the first constellation by selecting, from the second constellation, constellation points other than the first subset of constellation points and the second subset of constellation points.

6. A method comprising:
receiving modulated symbols;
demodulating the modulated symbols based on a first constellation, to recover a plurality of input bits; and
outputting the recovered plurality of input bits,
wherein the first constellation comprises constellation points that are consistent with a portion of a second constellation, and
the portion of the second constellation excludes a first subset of constellation points in the second constellation that are associated with lowest power and a second subset of constellation points in the second constellation that are associated with highest power.

7. The method of claim 6, wherein a dynamic range of power associated with constellation points in the first constellation is smaller than a dynamic range of power associated with all constellation points in the second constellation.

8. The method of claim 6, wherein a number of the input bits recovered from each of the modulated symbols based on the first constellation is less than a number of input bits associated with the second constellation.

9. The method of claim 6, further comprising:
pruning the first subset of constellation points and the second subset of constellation points from the second constellation to obtain the first constellation.

10. The method of claim 6, further comprising:
obtaining the first constellation by selecting, from the second constellation, constellation points other than the first subset of constellation points and the second subset of constellation points.

11. An apparatus comprising:
at least one processor; and
memory coupled to the at least one processor, the memory storing instructions that, when executed by the at least one processor, cause the apparatus to:
map input bits, based on a first constellation, to obtain a plurality of modulated symbols; and
output the plurality of modulated symbols,
wherein the first constellation comprises constellation points that are consistent with a portion of a second constellation, and
the portion of the second constellation excludes a first subset of constellation points in the second constellation that are associated with lowest power and a second subset of constellation points in the second constellation that are associated with highest power.

12. The apparatus of claim 11, wherein a dynamic range of power associated with constellation points in the first constellation is smaller than a dynamic range of power associated with all constellation points in the second constellation.

13. The apparatus of claim 11, wherein a number of the input bits mapped to each of the modulated symbols based on the first constellation is less than a number of input bits associated with the second constellation.

14. The apparatus of claim 11, wherein the instructions, when executed by the at least one processor, further cause the apparatus to:
prune the first subset of constellation points and the second subset of constellation points from the second constellation to obtain the first constellation.

15. The apparatus of claim 11, wherein the instructions, when executed by the at least one processor, further cause the apparatus to:
obtain the first constellation by selecting, from the second constellation, constellation points other than the first subset of constellation points and the second subset of constellation points.

16. An apparatus comprising:
at least one processor; and
memory coupled to the at least one processor, the memory storing instructions that, when executed by the at least one processor, cause the apparatus to:
receive modulated symbols;
demodulate the modulated symbols based on a first constellation, to recover a plurality of input bits; and
output the recovered plurality of input bits,
wherein the first constellation comprises constellation points that are consistent with a portion of a second constellation, and
the portion of the second constellation excludes a first subset of constellation points in the second constellation that are associated with lowest power and a second subset of constellation points in the second constellation that are associated with highest power.

17. The apparatus of claim 16, wherein a dynamic range of power associated with constellation points in the first constellation is smaller than a dynamic range of power associated with all constellation points in the second constellation.

18. The apparatus of claim 16, wherein a number of the input bits recovered from each of the modulated symbols based on the first constellation is less than a number of input bits associated with the second constellation.

19. The apparatus of claim 16, wherein the instructions, when executed by the at least one processor, further cause the apparatus to:
prune the first subset of constellation points and the second subset of constellation points from the second constellation to obtain the first constellation.

20. The apparatus of claim 16, wherein the instructions, when executed by the at least one processor, further cause the apparatus to:
obtain the first constellation by selecting, from the second constellation, constellation points other than the first subset of constellation points and the second subset of constellation points.
